(19) United States
(12) Patent Application Publication
(10) Pub. No.: US 2016/0207619 A1
(43) Pub. Date: Jul. 21, 2016

(54) LIGHT WEIGHT PROPULSOR GEARBOX

(71) Applicant: Sikorsky Aircraft Corporation, Stratford, CT (US)

(72) Inventors: David A. DARROW, JR., Stratford, CT (US); Thomas L. Tully, Oxford, CT (US)

(21) Appl. No.: 14/915,158

(22) PCT Filed: Aug. 27, 2014
(86) PCT No.: PCT/US14/52830

§ 371 Date: Feb. 26, 2016

Related U.S. Application Data
(60) Provisional application No. 61/871,118, filed on Aug. 28, 2013.

(51) Int. Cl. B64C 27/14; F16H 57/04; F16H 1/28

(52) U.S. Cl. CPC B64C 27/14; F16H 1/28; F16H 57/0441; F16H 57/0486

(57) ABSTRACT

A propulsor gearbox assembly for a translational thrust propeller includes a housing defining an interior cavity, a planetary gear assembly contained within the interior cavity, an input shaft aligned on a first axis or rotation, and an output shaft aligned along a second axis of rotation. The first axis of rotation is coaxial with the second axis of rotation.

### CROSS-REFERENCE TO RELATED APPLICATIONS

This application claims the benefit of U.S. Provisional Application Ser. No. 61/871,118, filed Aug. 28, 2013, the entire contents of which are herein incorporated by reference.

### STATEMENT REGARDING FEDERALLY SPONSORED RESEARCH OR DEVELOPMENT

This invention was made with Government support with the United States Army under Contract No. W911W6-13-2-0003. The Government therefore has certain rights in this invention.

### BACKGROUND

The subject matter disclosed herein relates to aircraft propulsion systems and to a lightweight gearbox for an auxiliary propulsor in a rotary wing aircraft.

### DESCRIPTION OF RELATED ART

A rotary wing aircraft with a coaxial contra-rotating rotor system is capable of higher speeds as compared to conventional single rotor helicopters. This is due in part to the balance of lift between advancing sides of the main rotor blades on the upper and lower rotor systems. To still further increase airspeed and thrust for high speed flight, supplemental thrust is provided by a translational thrust system. A translational thrust system can include an integrated propulsor unit with a propulsor (e.g., a propeller) oriented substantially horizontal and parallel to the aircraft's longitudinal axis located aft of the main rotor system.

Typically for an integrated propulsor unit, control of the propeller is provided by a propeller transmission unit. The transmission unit includes a speed reduction gearbox that is connected to input and output shafting. Pitch control of the propeller is done with a pitch actuation unit that is located within the gearbox housing. However, this configuration makes the gearbox increase in size and weight. Therefore, there is a need for a lightweight gearbox that minimizes weight and still provide thrust for high-speed flight.

### BRIEF SUMMARY

According to one embodiment of the invention, a propulsor gearbox assembly for a translational thrust propeller includes a housing defining an interior cavity; a planetary gear assembly contained within the interior cavity; an input shaft aligned on a first axis or rotation; and an output shaft aligned along a second axis of rotation. The first axis of rotation is coaxial with the second axis of rotation.

In addition to one or more of the features described above, or as an alternative, further embodiments could include a planetary gear assembly that comprises a sun gear connected to the input shaft.

In addition to one or more of the features described above, or as an alternative, further embodiments could include a planetary gear assembly that comprises a planetary carrier frame with a plurality of planetary gears.

In addition to one or more of the features described above, or as an alternative, further embodiments could include a planetary carrier frame is coupled to the output shaft along the second axis of rotation.

In addition to one or more of the features described above, or as an alternative, further embodiments could include a plurality of planetary gears that are configured to engage the sun gear and rotate radially around the sun gear.

In addition to one or more of the features described above, or as an alternative, further embodiments could include a planetary carrier frame that is configured to rotate around the sun gear in response to the rotation of the plurality of planetary gears.

In addition to one or more of the features described above, or as an alternative, further embodiments could include a gear-driven pump and a sump chamber contained within the interior cavity, where the gear-driven pump is configured to be driven by the planetary gear assembly.

In addition to one or more of the features described above, or as an alternative, further embodiments could include a plurality of bearings, with a pair of bearings supporting the input shaft and a pair of bearings supporting the output shaft.

In addition to one or more of the features described above, or as an alternative, further embodiments could include an input shaft that is configured to connect to a propeller drive shaft for receiving input torque.

In addition to one or more of the features described above, or as an alternative, further embodiments could include an input shaft that is configured to connect to a clutch assembly, wherein the clutch assembly is in mechanical engagement with the propeller drive shaft for receiving input torque.

In addition to one or more of the features described above, or as an alternative, further embodiments could include an output shaft that is configured to be connected to a propeller.

According to another embodiment of the invention, a method of providing auxiliary thrust to a translational thrust propeller includes providing a propulsor gearbox; connecting a propeller drive shaft to the input shaft of the propulsor gearbox; connecting the translational thrust propeller to the output shaft of the propulsor gearbox; and providing input torque to the propeller drive shaft and rotationally driving the planetary gear assembly.

In addition to one or more of the features described above, or as an alternative, further embodiments could include a propulsor gearbox comprising: a housing defining an interior cavity; a planetary gear assembly contained within the interior cavity; an input shaft connected to a sun gear of the planetary gear assembly and aligned on a first axis or rotation; and an output shaft connected to a planetary carrier frame of the planetary gear assembly and aligned along a second axis of rotation. The first axis of rotation is coaxial with the second axis of rotation.

In addition to one or more of the features described above, or as an alternative, further embodiments could include providing a gear-driven pump and a sump chamber within the interior cavity.

In addition to one or more of the features described above, or as an alternative, further embodiments could include, a gear-driven pump that is configured to be driven by the planetary gear assembly.

In addition to one or more of the features described above, or as an alternative, further embodiments could include connecting a clutch assembly between the tail propeller drive shaft and the input shaft.

In addition to one or more of the features described above, or as an alternative, further embodiments could include a clutch assembly that is in mechanical engagement with the propeller drive shaft for receiving the input torque.

In addition to one or more of the features described above, or as an alternative, further embodiments could include transmitting the input torque to the planetary carrier frame and rotationally driving the output shaft.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 is a general side view of a rotary wing aircraft according to an embodiment of the invention;

FIG. 2 is a perspective view of an example transmission system of the rotary wing aircraft of FIG. 1 according to an embodiment of the invention;

FIG. 3 is a cross-section view of a propulsor gearbox of the rotary wing aircraft of FIG. 1 according to an embodiment of the invention; and

FIG. 4 is a perspective view of the propulsor gearbox of FIG. 3 according to an embodiment of the invention.

### DETAILED DESCRIPTION OF THE INVENTION

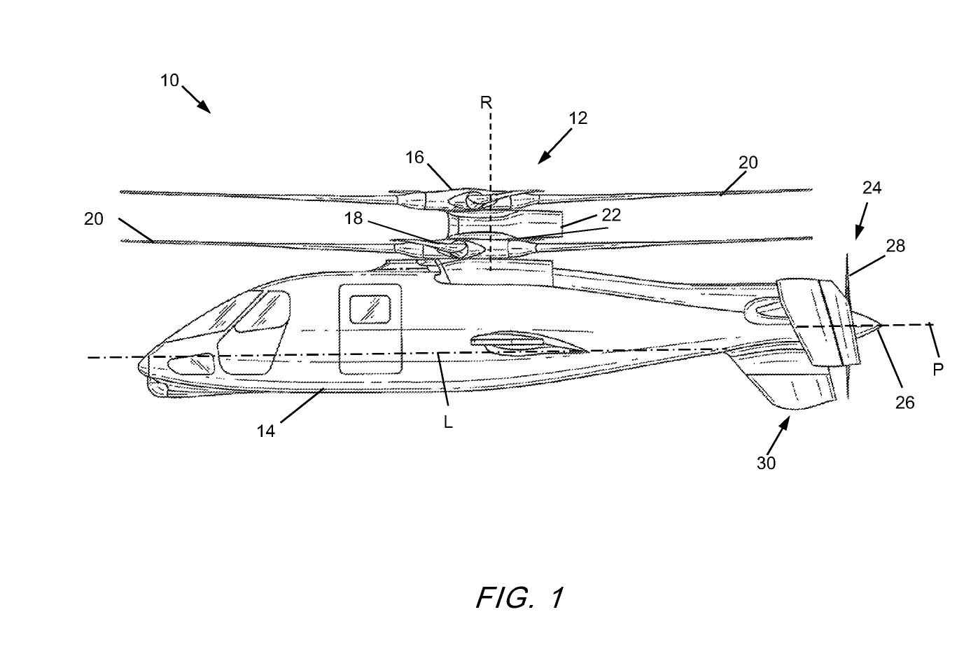

Referring to the drawings, FIG. 1 illustrates an example of a vertical takeoff and landing (VTOL) high speed compound or coaxial contra-rotating rotary wing aircraft 10 with an airframe 14 which supports a dual, contra-rotating main rotor system 12 and a translational thrust system 24. The translational thrust system 24, as shown, is located at a tail-section of aircraft 10. Alternatively, the translational thrust system 24 may be located at a mid-point of aircraft 10 and can include a pusher propeller, a tractor propeller, a nacelle mounted propeller, etc. The main rotor system 12 rotates about a rotor axis of rotation R and is driven for rotation by one or more engines 22. The main rotor system 12 includes an upper rotor system 16 and a lower rotor system 18 as dual contra-rotating main rotors in a coaxial configuration. Main rotor system 12 includes a plurality of rotor blades 20 mounted to each rotor system 16, 18 for lift, anti-torque and thrust.

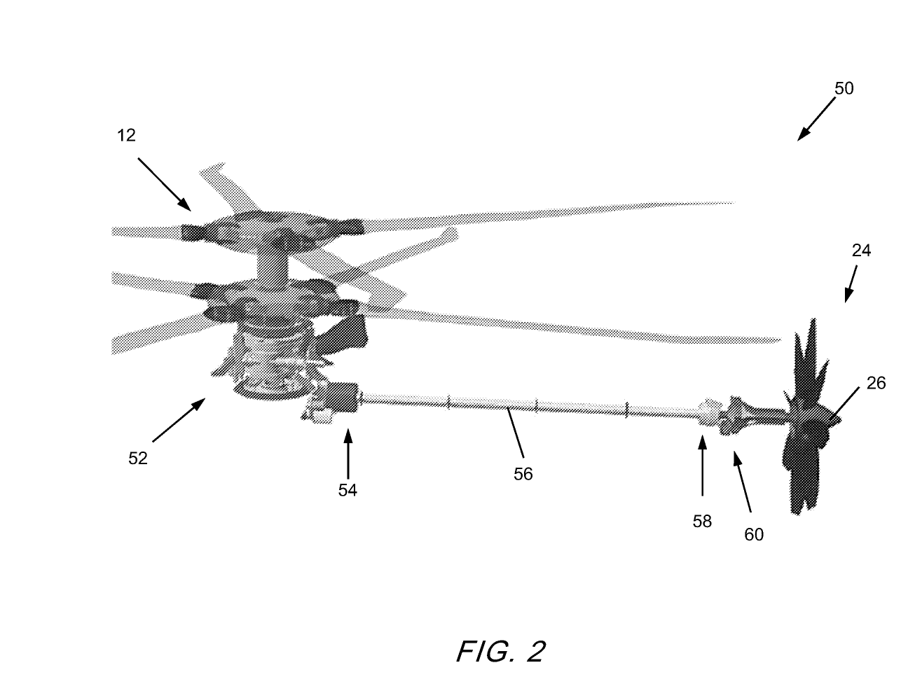

Also shown in FIG. 1, translational thrust system 24 provides supplemental or auxiliary thrust for aircraft 10. Translational thrust system 24 includes a propeller 26 with a plurality of propeller blades 28. In an embodiment, propeller 26 is positioned at a tail section 30 of aircraft 10 and is a pusher propeller system with a propeller rotational axis P oriented substantially horizontal and parallel to the aircraft longitudinal axis L in order to provide supplemental thrust for high speed flight. The translational thrust system 24 is driven for rotation by engines 22 through a speed reduction transmission system 50 which is shown and described below in reference to FIG. 2. Although a particular configuration of rotary wing aircraft 10 is illustrated and described in the disclosed non-limiting embodiments, other configurations and/or machines with rotor systems are within the scope of the present invention.

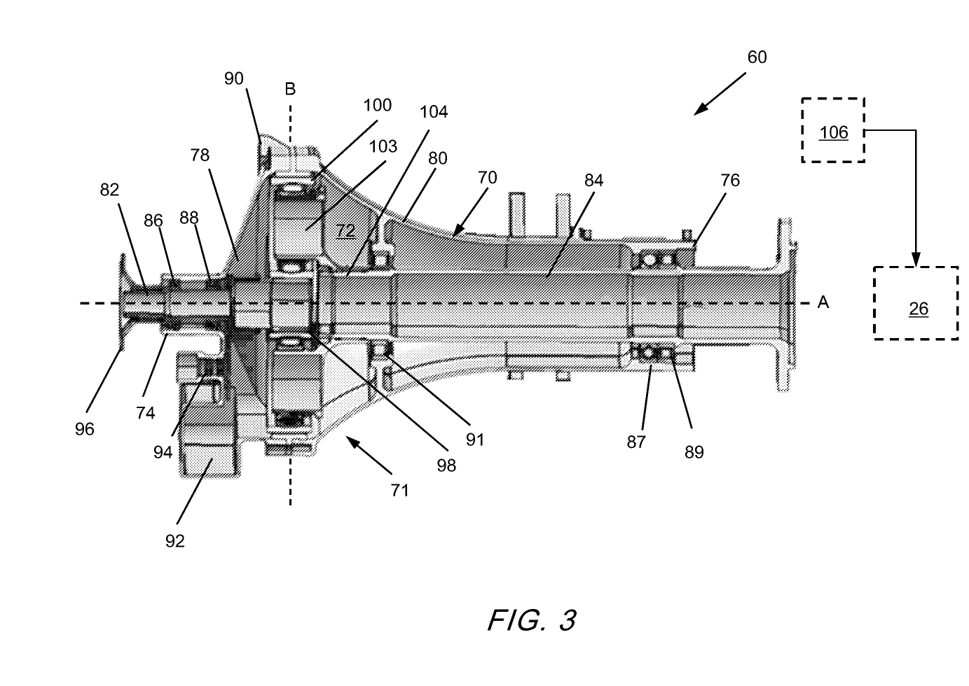

Referring to FIG. 2, a perspective view of a transmission system 50 of aircraft 10 is illustrated according to an embodiment of the invention. In an embodiment, transmission system 50 includes a main gearbox 52, an intermediate gearbox 54, a tail propeller drive shaft 56 and a translational thrust system 24. The translational thrust system 24 can include a clutch assembly 58 in mechanical engagement with propulsor gearbox 60. Main gearbox 52 can be a split-torque gearbox and transmits input torque that is received from engines 22 to rotationally drive main rotor system 12 and translational thrust system 24. Translational thrust system 24 is driven through a drivetrain path. In an embodiment, drivetrain path can include an intermediate gearbox 54 in meshing engagement with main gearbox 52. Intermediate gearbox 54 transmits input torque from main gearbox 52 to a tail propeller drive shaft 56. The intermediate gearbox 54 has a defined gearbox ratio to provide speed reduction (in revolutions per minute or “rpm”) from an initial rpm at main gearbox 52 to a lower rpm at tail propeller drive shaft 56. In an embodiment, intermediate gearbox 54 has a gearbox ratio of about 1.626 to 1 to provide speed reduction at tail propeller drive shaft 56. Other gearbox ratios are also contemplated in the invention. The tail propeller drive shaft 56 can be connected to an input shaft 82 (FIG. 3) of the propulsor gearbox 60 in order to transmit torque from the drive shaft 56. In addition or as an alternative, an embodiment could include a clutch assembly 58 mechanically connected between tail propeller drive shaft 56 and input shaft 82 (FIG. 3) in order for a smooth engagement of torque at propulsor gearbox 60. The propulsor gearbox 60 further reduces the speed of rotation received from tail propeller drive shaft 56 to drive propeller 26 at a defined speed. Propulsor gearbox 60 has a single-stage planetary gear train, which has a specific gearbox ratio to provide speed reduction to propeller 26. In an embodiment, propulsor gearbox 60 has a gearbox ratio of about 5.86 to 1 to provide speed reduction to propeller 26.

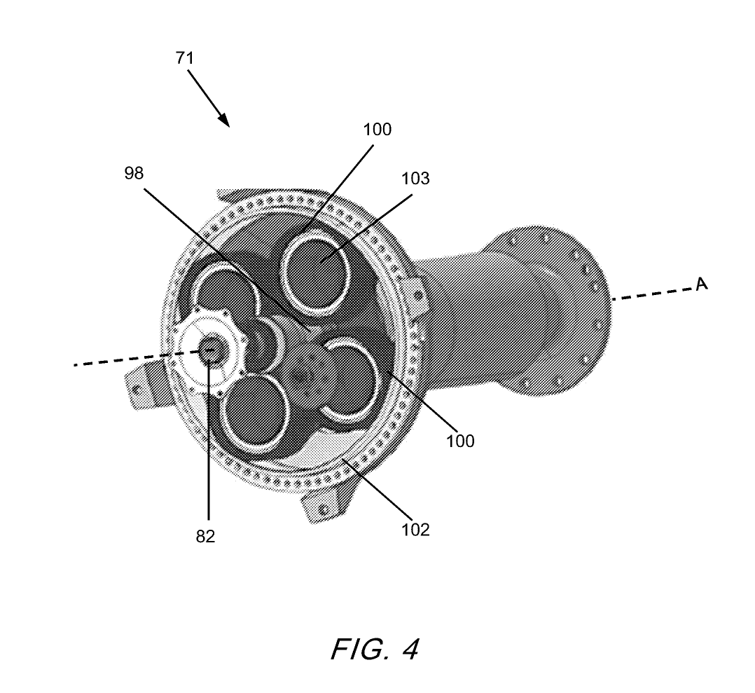

Referring to FIGS. 3 and 4, propulsor gearbox 60 with a single-stage planetary gear train 71 is shown according to embodiments. Propulsor gearbox 60 has a housing assembly 70, which includes a first portion 78 selectively attached to a second portion 80 with bolts, screws, or the like. Housing assembly 70 extends from a proximal end 74 to an aft end 76 and houses an internal cavity 72 along its longitudinal length. Internal cavity 72 is provided to receive respective input and output shafts 82, 84, planetary gear train 71 and associated bearings, as will be described in further detail below.

As shown in FIG. 3, housing assembly 70 has a first portion 78 with a first internal diameter at proximal end 74. First internal diameter increases to a second internal diameter at axis B. First internal diameter is sized to receive input shaft 82 that is constrained by its associated roller bearings 86, 88 at proximal end 74. First portion 78 also includes an integral wet sump oil system with a sump chamber 92 and a gear-driven pump 94 for circulating lubrication fluid to planetary gear train 71 and shafts 82, 84 during operation of gearbox 60. A plurality of substantially similar protrusions 90 are provided along an outer circumferential edge of first portion 78 along axis B to couple housing assembly 70 to a similar shaped annular bulkhead (not shown). Similarly, second portion 80 has a third internal diameter at aft end 76 that increases to a fourth internal diameter at axis B. Third internal diameter is sized to contain an output shaft 84 and its associated roller bearing 87 and angular contact bearing 89 at aft end 76. An additional contact bearing 91 may be provided to constrain shaft 84. Bearings 86, 87, 88, 89 and 91 function to constrain shaft thrust and bending moments that are experienced by input and output shafts 82 and 84. In an embodiment, second internal diameter is substantially the same as fourth internal diameter so as to selectively couple first portion 78 to second portion 80 along axis B. As shown schematically, a propeller pitch actuation system 106 may be provided externally and independent of propulsor gearbox 60.

Referring now to FIG. 4 with continued reference to FIG. 3, planetary gear train 71 has a sun gear 98, planetary gears 100 and an outer ring gear 102. Sun gear 98 is aligned along longitudinal axis A which defines an axis of rotation for sun gear 98. Planetary gears 100 are arranged radially about sun gear portion 98 and are coupled to a movable planetary carrier frame 103. Planetary carrier frame 103 has a center flange 104 (FIG. 3) that is also aligned along longitudinal axis A which defines an axis of rotation for planetary carrier frame 103. Planetary gears 100 are in meshing engagement with sun gear 98 and outer ring gear 102. Sun gear 98 is coupled to an end of input shaft 82 thereby aligning input shaft 82 along longitudinal axis A. Also planetary carrier frame 103 is coupled to an end of output shaft 84 through flange 104 which also aligns output shaft 84 along longitudinal axis. As torque is applied to input shaft 82 to cause it to rotate, sun gear 98 also rotates about axis A and the resulting applied force is transmitted from sun gear 98 to planetary gears 100 and onto planetary carrier frame 103. As planetary gears 100 rotate and revolve around outer ring gear 102, planetary carrier frame 103 rotates about longitudinal axis A and transmits the received torque to output shaft 84. Output shaft 84 also rotates coaxially with input shaft 82 about longitudinal axis A. Thereby, torque from input shaft 82 is transmitted through propulsor gearbox 60 to output shaft 84 and to propeller 26 (shown schematically in FIG. 3) through a coaxial arrangement of input shaft 82 and output shaft 84.

Prior art propulsor gearboxes utilize multiple-stage planetary gear trains for speed reduction. As prior art propulsor gearboxes implement pitch actuation in the gearbox, the requirement that input shaft and output shaft are coaxial is provided through at least a two-stage planetary gear train. However, in the present invention of propulsor gearbox 60, as propeller pitch actuation system at propulsor gearbox 60 is eliminated, the requirement for controlling access to pitch actuator rods within propulsor gearbox 60 is also eliminated. Another benefit of the configuration of propulsor gearbox 60 is that input shaft 82 is aligned coaxially with output shaft 84 through use of a single-stage planetary gear train 71 for speed reduction. Elimination of propeller pitch actuation with propulsor gearbox 60 also provides a very simplistic and lightweight design that minimizes weight of propulsor gearbox 60. Additional benefits include an integral lubrication system through an integral oil pump 94 that eliminates external lines to carry lubrication to propulsor gearbox 60.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. For instance, aspects of the invention are not limited to propeller blades for aircraft, and can be used in wind turbines and other systems with rotary elements. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. A propulsor gearbox assembly for a translational thrust propeller, comprising:
a housing defining an interior cavity;
a planetary gear assembly contained within the interior cavity;
a gear-driven pump and a sump chamber contained within the interior cavity, wherein the gear-driven pump is configured to be driven by the planetary gear assembly;
an input shaft aligned on a first axis or rotation; and
an output shaft aligned along a second axis of rotation;
wherein the first axis of rotation is coaxial with the second axis of rotation.

2. The propulsor gearbox assembly of claim 1, wherein the planetary gear assembly comprises a sun gear connected to the input shaft.

3. The propulsor gearbox assembly of claim 2, wherein the planetary gear assembly comprises a planetary carrier frame with a plurality of planetary gears.

4. The propulsor gearbox assembly of claim 3, wherein the planetary carrier frame is coupled to the output shaft along the second axis of rotation.

5. The propulsor gearbox assembly of claim 3, wherein the plurality of planetary gears are configured to engage the sun gear and rotate radially around the sun gear.

6. The propulsor gearbox assembly of claim 4 or 5, wherein the planetary carrier frame is configured to rotate around the sun gear in response to the rotation of the plurality of planetary gears.

7. (canceled)

8. The propulsor gearbox assembly of claim 1, further comprising a plurality of bearings, with a pair of bearings supporting the input shaft and a pair of bearings supporting the output shaft.

9. The propulsor gearbox assembly of claim 1, wherein the input shaft is configured to connect to a propeller drive shaft for receiving input torque.

10. The propulsor gearbox assembly of claim 9, wherein the input shaft is configured to connect to a clutch assembly, wherein the clutch assembly is in mechanical engagement with the propeller drive shaft for receiving input torque.

11. The propulsor gearbox assembly of claim 1, wherein the output shaft is configured to be connected to a propeller.

12. A method of providing auxiliary thrust to a translational thrust propeller, comprising:
providing a propulsor gearbox; wherein the propulsor gearbox includes:
a housing defining an interior cavity;
a planetary gear assembly contained within the interior cavity;
an input shaft connected to a sun gear of the planetary gear assembly and aligned on a first axis or rotation; and
an output shaft connected to a planetary carrier frame of the planetary gear assembly and aligned along a second axis of rotation;
wherein the first axis of rotation is coaxial with the second axis of rotation.
connecting a propeller drive shaft to the input shaft of the propulsor gearbox;
connecting the translational thrust propeller to the output shaft of the propulsor gearbox;
providing input torque to the propeller drive shaft and rotationally driving the planetary gear assembly; and
providing a gear-driven pump and a sump chamber within the interior cavity, wherein the gear-driven pump is configured to be driven by the planetary gear assembly.

13. (canceled)

14. The method of claim 12, further comprising connecting a clutch assembly between the tail propeller drive shaft and the input shaft, wherein the clutch assembly is in mechanical engagement with the propeller drive shaft for receiving the input torque.

15. The method of claim 12, further comprising transmitting the input torque to the planetary carrier frame and rotationally driving the output shaft.
